(19) United States
(12) Patent Application Publication
(10) Pub. No.: US 2005/0280384 A1
(43) Pub. Date: Dec. 22, 2005

(54) Air delivery system and method

(76) Inventor: Louis E. Sulfstede, Irving, TX (US)

Correspondence Address: MICHAEL L. DIAZ, P.C., 555 REPUBLIC DRIVE, SUITE 200, PIANO, TX, 75074, US

(21) Appl. No.: 11/209,923

(22) Filed: Aug. 23, 2005

Related U.S. Application Data
(63) Continuation-in-part of application No. 10/234,264, filed on Sep. 4, 2002, now abandoned.
(60) Provisional application No. 60/317,323, filed on Sep. 5, 2001.

(51) Int. Cl. H02P 7/00

(52) U.S. Cl. 318/432

(57) ABSTRACT

A system and method of controlling airflow within an air delivery system. The method begins by identifying and measuring a particular air conditioning system's blower characteristics. A mathematical relationship for finding a particular CFM based on torque and speed is developed utilizing several discrete airflows within regions or bins within a designated range. The mathematical model is employed by a controller of the air conditioning system for controlling CFM. Additionally, the method may optionally change from an airflow control mode to a blower speed or torque control mode when restrictions are placed upon the air conditioning system.

### RELATED APPLICATIONS

This application is a continuation-in-part of a co-pending U.S. patent application Ser. No. 10/234,264 entitled “SYSTEM AND METHOD OF CONTROLLING AIRFLOW IN AN AIR DELIVERY SYSTEM” filed Sep. 4, 2002 in the name of Louis E. Sulfstede, which claims priority of Provisional Patent Application Ser. No. 60/317,323 filed Sep. 5, 2001, which is hereby incorporated in its entirety by reference herein.

### BACKGROUND OF THE INVENTION

1. Field of the Invention

This invention relates to the control of delivered air in air delivery systems and, more particularly, to a system and method of controlling airflow by a discrete bin airflow mathematical model in an air delivery system.

2. Description of the Related Art

There have been many systems implemented to optimize airflow within an air conditioning system. Typically, the air conditioning system includes a device to condition the temperature of the air, with the delivery rate of the conditioned air regulated by a motor driving a blower. Many factors affect the amount of air and the rate of air delivery (often measured as CFM-cubic feet per minute). Such factors include the blower wheel design and type, the motor's speed and torque, restrictions associated with the blower, and the temperature and density of the air. Variations in blower restriction are the main reason for the change in airflow during the operating life of an air delivery system. The effects of filters getting dirty, vents and dampers being blocked or adjusted by the user, and deterioration of the air delivery ductwork all contribute to additional restrictions being placed on the inlet and outlet of a blower. It is therefore advantageous if the airflow be held constant over the life the equipment to compensate for these changes in restriction.

In most situations, it is highly desirable to provide a controlled airflow to the air space. Controllers located within existing air conditioning systems are used to control the speed or torque of the motor driving the blower or adjust dampers to provide the desired airflow. Those controllers that adjust the motor's performance set the desired airflow based upon an airflow performance mathematical model. As an example, in order to develop a constant airflow performance model, the relevant factors influencing the CFM include the motor's speed and torque, the blower's airflow, and static pressure of the environment are modeled. Since the torque and speed of the motor are related to the restriction on the blower at a given airflow, the model of this airflow may relate air mass or volume (if density is known) per unit time to torque and speed of the motor. Therefore, at a specified torque and speed of a motor, the air delivered into a restriction can be approximated.

In order to determine a mathematical model of constant airflow for all types of fans, complicated formulas must be utilized employing factors dependent upon the characteristics and performance of the specific type of blower of each air conditioning system. However, the derived mathematical model for one blower or fan cannot produce controlled CFM representations for all blower geometries, sizes, or air conditioning systems. Using such a generalized mathematical model to cover all airflows over a particular range (also know as a continuum of airflows), requires complex computations and significant processing resources. Thus, to facilitate the preferred airflow process control within air conditioning systems, costly resources must be used.

Although there are no known prior art teachings of a solution to the aforementioned deficiency and shortcoming such as that disclosed herein, a prior art reference that discuss subject matter that bears some relation to matters discussed herein is U.S. Pat. No. 4,806,833 to Young (Young), U.S. Pat. No. 5,736,823 to Nordby et al. (Nordby), U.S. Pat. No. 4,977,896 to Shah (Shah), U.S. Pat. No. 5,559,407 to Dudley et al. (Dudley), and U.S. Pat. No. 5,202,951 to Doyle (Doyle).

Young discloses an air delivery system which produces a desired airflow over a continuous range. The static pressure is varied to affect an alteration in the speed of the blower. Referring to FIG. 4 in Young, the figure merely discloses the relationship of CFM to speed and torque and various static pressures. Young does not disclose a controller which determines a torque and RPM of the motor to produce a desired CFM air flow from a plurality of discrete airflows within bins. Young merely utilizes a controller which, as static pressure varies to affect the alteration in the speed of the blower to supply constant airflow, controls over a continuous range airflow, rather than utilizing a specific set of discrete airflows.

Nordby discloses an air handling device which delivers air at a constant airflow. Nordby employs a mathematical formula in a microprocessor that is part of the motor drive or controller that defines a continuum airflow region. To establish the equation that is to be employed in the microprocessor, Nordby utilizes four linear equations (i.e., airflow lines), determined by testing a blower. From those four linear equations, Nordby solves for constants that define an equation of the form: “torque=(K1*S*C)+(K2*S)+K4” (Col. 4, line 10) that defines a continuum of airflows. Nordby does not teach or suggest defining equations for a discrete series of airflow bins. FIG. 3 in Nordby merely shows curves that are linear fits to test data that is used to develop the torque equation. Nordby then programs that torque equation into the microprocessor of the control system. Nordby's process still suffers from the disadvantage of utilizing a complex higher order equation which requires far greater microprocessor resources.

Shah discloses an apparatus for controlling a motor in an air delivery system. Shah discloses the use of multiple equations to define an airflow continuum, as well as speed limits that must be applied within the continuum. Furthermore, Shah discloses that the constants relating to the speed parameter of the equation must be modified dependent upon the speed region in which the blower is operating. Shah requires the use of several complex equations to define the airflow continuum. Additionally, Shah does not disclose calculating a unique mathematical relationship related to torque and RPM of the motor to create a plurality of discrete airflows. Rather, the mathematical relationship of Shah is described over a continuum of airflows. Shah also does not disclose an algorithm that limits torque within the airflow continuum until a fixed speed is reached that is a constant through the continuum.

Dudley discloses an apparatus for controlling an air delivery system. Dudley varies voltage and speed of the motor to provide an airflow. However, Dudley does not approximate a continuum of airflows with a series of airflow bins or mathematical relationships based solely on blower characteristics, speed of a motor and torque of the motor.

Doyle discloses a system and method for controlling an electronically commutated motor driving a blower to maintain the mass flow rate of the blower at a desired value. Doyle does not teach or suggest approximating a continuum of airflows with a plurality of discrete airflow bins.

All of the existing systems use a single or multiple complex mathematical equations for use over a range or continuum of airflows. A system and method is needed which does not require complex computations or processing resources to predict CFM performance. It would be advantageous to have a system which utilizes a single simple equation that can be equipped with a plurality of coefficients defined for specific discrete or digital airflows, rather than single or multiple complex mathematical equations defining an entire continuum of airflows. Additionally, a system and method is needed which applies a separate and independent torque limit for each discrete airflow. The present invention provides such a system and method.

### SUMMARY OF THE INVENTION

In one aspect, the present invention is an air delivery system. The air delivery system includes a blower for delivering an air flow to a specified area and a motor for driving the blower. The air delivery system also includes a controller for controlling air delivery to the specified area. The controller determines a torque and revolutions per minute (RPM) of the motor to produce a desired cubic feet per minute (CFM) air flow from a plurality of discrete airflows within bins. The controller commands the motor to the determined torque and RPM. The motor drives the blower to deliver the air flow at the desired CFM air flow.

In another aspect, the present invention is a method of controlling an air delivery system. The method begins by determining a total fan performance of a blower over an operational range of the air delivery system. Next, a complex mathematical relationship that describes the airflow over the entire range, or continuum, of the air delivery system, based on torque and speed of a motor driving the blower is developed. This is also known as the fan curve. To this higher order mathematical relationship, a specific set of lower order relationships is curve-fitted to create a plurality of discrete airflow relationships. Each discrete equation describes a specific CFM air flow. A controller of the air delivery system utilizes this simpler, unique mathematical relation to control the RPM and torque of the motor to deliver a desired CFM airflow.

In still another aspect, the present invention is a method of controlling an air delivery system utilizing a variable limit. The method begins by determining a total fan performance of a blower over an operational range of the air delivery system. Next, a unique mathematical relationship of CFM airflow related to torque and RPM of a motor driving the blower to create a plurality of discrete airflows within the operational range of the air delivery system is calculated. It is then determined if a controlled airflow mode constant airflow mode or a constant torque mode is desired for the air delivery system. If a controlled airflow mode constant airflow mode is determined, a controller of the air delivery system utilizes the unique mathematical relationship for a specific discrete airflow to control the RPM and torque of the motor to deliver a desired CFM airflow. However, if it is determined that a constant torque mode is desired for the air delivery system, the controller commands a constant torque to the motor to permit the blower to respond to normal fan curve performance models.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 (Prior Art) is a graphical representation of a fan curve showing a series of constant pressure and RPM curves which define airflow and power;

FIG. 2 is a graphical representation of a series of CFM curves such that any airflow between or beyond the curves may be achieved according to the teachings of the present invention;

FIG. 3 is a simplified block diagram illustrating the components of an air conditioning system in the preferred embodiment of the present invention;

FIG. 4 is a simplified block diagram describing the discrete airflow bin selection process and torque calculations in the preferred embodiment of the present invention;

FIG. 5a is a flow chart outlining the steps for pre-processing the blower data in preparation for implementing the discrete airflow model according to the teachings of the present invention;

FIG. 5b is a flow chart outlining the steps of implementing airflow control in the air conditioning system utilizing a variable limit according to the teachings of the present invention;

FIG. 6 is a flow chart outlining the steps of the full control process including control in the limit conditions according to the teachings of the present invention;

FIG. 7 illustrated a side view of an existing forward curved blower; and

FIG. 8 illustrates a fan curve of the blower characteristics of the exemplary forward curved blower of FIG. 7 relating airflow to power and pressure blower;

### DESCRIPTION OF THE INVENTION

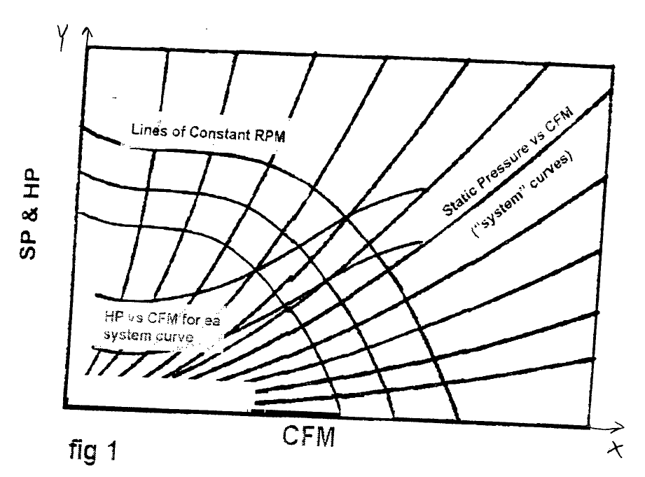

FIG. 1 is a graphical representation of a plurality of rates of air flow (CFMs-cubic feet per minute) based upon speed and horsepower of a motor within an existing air conditioning system. FIG. 1 (Prior Art) is a graphical representation of a fan curve, or air flow continuum, onto which, for clarification, is shown a series of constant pressure and RPM curves which define airflow and power. Anywhere within this continuum and, not only as described on the example curves themselves, a plurality of rates of air flow (CFM-cubic feet per minute) based upon speed and horsepower of a motor within an existing air conditioning system can be determined. To develop a mathematical model to produce a specific airflow performance in a system, a blower's specified performance data in an air conditioning system and its motor characteristics are measured and quantified. Specifically, the blower's airflow, and the motor's speed and torque are measured over a range of restriction (pressure) to produce curves as shown in FIG. 1. The torque and speed of the blower are related to the restriction on the blower at a given airflow. From this specific torque and speed of the motor, an air flow rate is derived. In order to find the specific characteristics of each individual and unique blower system, airflow is measured in a laboratory across the full range of external restrictions. The measured data is used to create a mathematical function of the form CFM=f(T,S) that serves as a model to describe the physics of the process. There are various models which can be used to describe the measured data of the blower. However, that accuracy and effectiveness of any specific formula is dependent upon the characteristics and performance of the blower utilized in the air conditioning system.

The mathematical model so derived is defined over more than two dimensions and typically involves solving for torque-speed solutions using exponential or logarithmic equations for any specified CFM at any blower system restriction. For example, formulas such as the following can be used:
CFM=Ko*logRPM+K1*logT+K2
or
CFM=Ko*RPMˆK1+K2*TˆK3+K4.
Where: T=Torque, RPM=blower speed, and Kx are constants. Such mathematic models can be formulated to approximate the system fan laws and power curves over a region of operation. FIG. 1 is an example of such a graphical representation describing airflow in terms of the torque and speed of the motor needed to hold airflow delivered by a particular blower configuration constant through a range of external restrictions over a range of commanded air flows. Performance data of fans and blowers are published by the fan manufacturer as part of the blower specification. FIG. 1 is an exemplified representation of such published data.

Referring to FIG. 1, the Y axis measures the speed/horsepower of the motor, while the X axis defines specific CFMs. Lines of constant RPM and static pressure vs. CFM curves are also illustrated. Because of the shape variations among blowers of different types, it should be noted that one particular mathematical model will not be capable of producing airflow control in all blower geometries, sizes or systems.

Some existing air conditioning systems use a mathematical model to monitor speed and adjust motor current to maintain CFM as commanded. However, this requires the use of complex mathematical computations, and significant processing resources must be employed within the motor control system to compute and control the desired CFM.

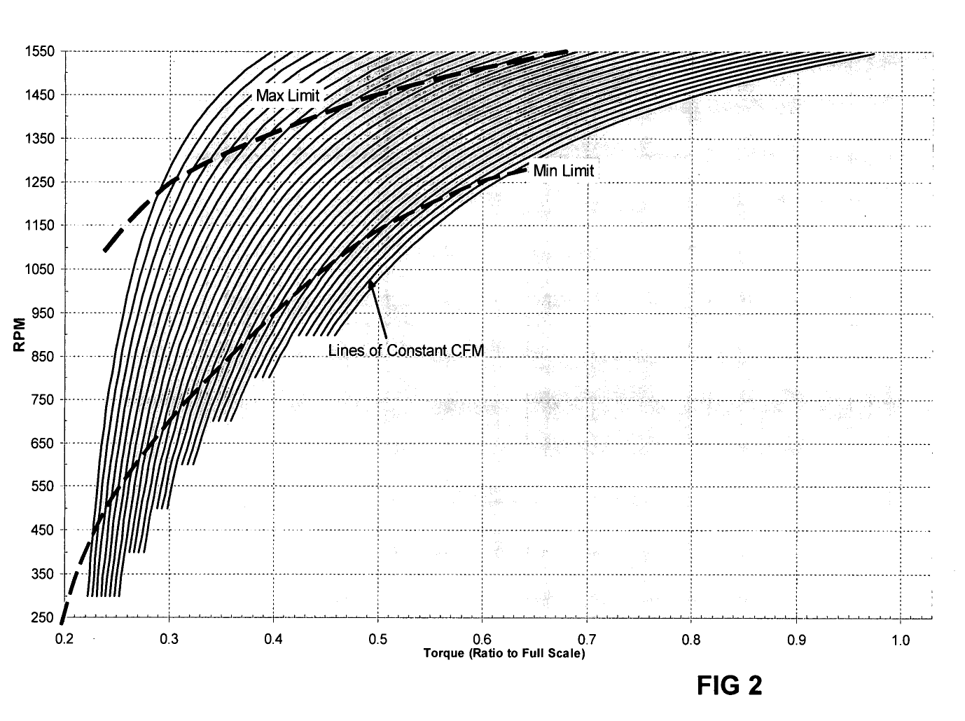

FIG. 2 is a graphical representation of a series of CFM curves, such that any airflow between or beyond the curves may be achieved. Each curve representing a discrete airflow, rather than a continuum of airflows. Rather than applying complex computations as would be required to define the relationships shown in FIG. 1, a simpler model may be calculated to cover a range of blower characteristics for a set of specific, single airflows over the fan's performance range. Before any functions are implemented into the control, the total fan performance is modeled over the operational range utilizing the mathematical relationship of: CFM=f(Torque, RPM) specific to the blower configuration. Then, several discrete airflows within that mathematical relationship are selected. Those discrete airflows are fit to a second simpler curve that relates speed and torque of that specified airflow over the narrow range of restrictions relevant to that discrete airflow. This second, unique equation is specific to a particular CFM airflow and cannot be used for a continuum of airflows. With the speed of the blower motor known, torque can be computed from the calculated equation and used to control CFM to the desired value required by the air conditioning system. Thus, discrete regions or bins are established through the range of the blower's performance. For example, for a particular blower configuration, each discrete step equation could be of the form of a quadratic function (rather than a complex, transcendental function):

T=K*RPMˆ2+K1*RPM+K2 for the discrete airflow, known as CFMᵢ. For other blower wheels or blower configurations, the discrete equations may be linear or of a higher order order in form, but would relate the commanded torque only to speed, not CFM to speed and torque.

An example for controlling airflow to a series of constant values is shown in FIG. 2. A family of constant CFM curves fitted from a mathematical model derived from data taken for a particular blower is illustrated. Each curve has a representative second order equation that relates torque to speed for each CFM curve over a narrower range of relevant external static pressure regions. The Y axis represents RPM of the blower, while the X axis represents percentage of full scale motor torque. In addition, a low torque and high torque limits are indicated by the two lines labeled “Lo Torque Speed Limit” and “Hi Torque Speed Limit”. The points of intersection of these lines and the discrete constant airflow lines show that the limits are modified for each constant airflow bin in the collection of constant airflows. For clarity, FIG. 2 shows a curved line for each of the maximum and minimum limits. However, the limits are actually points at maximum and minimum positions on each discrete airflow line with all of the points being connected in the figure.

By utilizing a process in which airflow control is accomplished in individual bins or regions through the range of the blower's performance using local equations to describe the blower torque and speed, which is a limited torque and speed range. This is limited to only that narrow set of values needed to characterize the airflow specified by that bin. The implementation of the airflow control is considerably simpler and has much broader application than by utilizing a single generalized mathematical model. These bins or regions are discrete and when implemented mathematically, are digital, rather than analog, in nature. In prior art, the mathematical formulae cover a continuum of airflows. The present invention selects distinct, discrete equations which describe a particular and discrete CFM airflow. Each equation represents a specific (digital) airflow and cannot be used over a continuum of airflows. In addition, no airflows between the discrete airflow lines shown in FIG. 2 can be obtained. The advantage of this approach removes the need for storage of complex multidimensional or transcendental mathematical models in the control system. This means processing resources and associated complexities inherent in complex computing are significantly reduced. Also, the mathematical solutions for torque and speed are much easier and faster to compute from the discrete regional relations as compared to finding solutions to the overall multidimensional mathematical model, especially when transcendental mathematical terms are used. This can result in reduced implementation cost.

The implementation of this simpler process is done in two major steps as follows:

1. Pre-implementation:

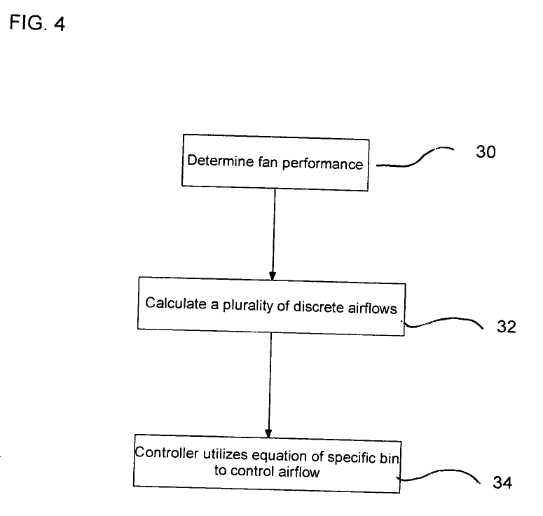

a. the blower is characterized by testing to obtain the blower curves;
b. the number of discrete airflows are decided upon; and
c. they are then fit to the selected equation (quadratic, for example) by determining coefficients.
   2. Implementation into the Airflow Control:
a. The coefficients are programmed into the controller in a table.
b. The appropriate discrete airflow is selected based on an input command to the controller which provides a computer torque (See FIG. 4).

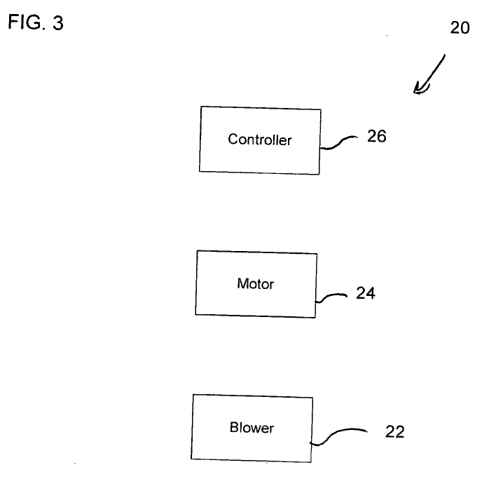

Through this process, it can be clearly seen that the most complex mathematical operations are accomplished before the control is implemented so that the controller does not need to perform such a computation. Only the coefficients of the localized equations need to be stored. Each set is called up for computation only when commanded at particular blower airflow in the specified bin. FIG. 3 is a simplified block diagram illustrating the components of an air conditioning system 20 in the preferred embodiment of the present invention. The air conditioning system may be any heating, ventilation, air conditioning (HVAC) or air delivery system employing the controller 26. System 20 includes a blower 22 driven by a motor 24 and controlled by a controller 26. The blower delivers airflow over a particular region. The controller commands the airflow from the motor so that it calculates and adjusts torque and RPM to produce the desired CFM. The controller may include a computing system to calculate and receive mathematically relationships or programs. The controller is normally located external of the motor's internal controls. For simplification, not all components are illustrated within the air conditioning system 20.

FIG. 4 is a simplified block diagram describing airflow bin selections and torque calculations in the preferred embodiment of the present invention. First, inputs from the system provide the controller 26 with a discrete airflow selection command for a specified discrete/digital airflow. The controller selects a discrete airflow from a plurality of distinct discrete airflows. Additionally, by selecting the specific airflow, the controller simultaneously selects a specific set of constants. Each set of constants is associated with a specific discrete airflow.

Still referring to FIG. 4, the selected coefficients define, in this example, a quadratic equation (torque calculator) that produces a single, discrete airflow commanded by the input. The quadratic equation is a simple fit to a discrete “region” of a complex higher order equation relating speed (S) and torque (T) to a single airflow. This region fitting approach means that the higher order equation is not implemented in the control, as done in the prior art, thus simplifying the implementation. Once the coefficients are selected and inserted into the torque calculation, a specific motor command is calculated at each speed. In the present invention's most basic form, a controller may select and command a specific airflow by utilizing a plurality of coefficients for a single equation form. The equation, once employing the coefficients, defines the torque and operating speed necessary to describe a single discrete airflow. The equation may be quadratic or even a higher order equation, depending on the particular best fit to the blower curves. Alternatively, if the highest accuracy is not required, the equation may be a simple linear approximation that reduces computing resources even further.

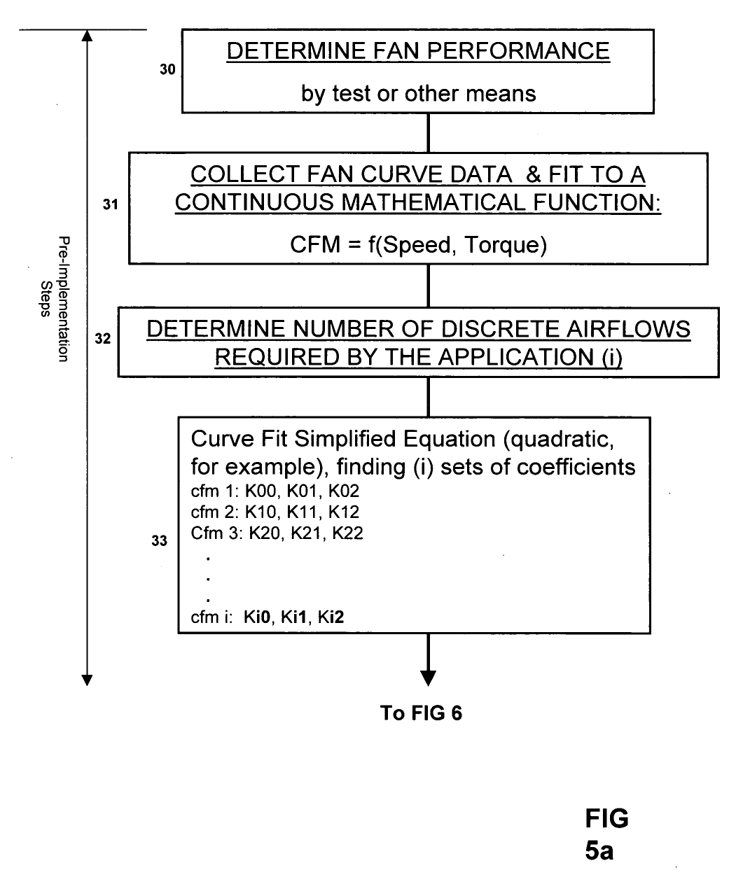

FIG. 5a is a flow chart outlining the steps for pre-processing the blower data in preparation for implementing the discrete airflow model according to the teachings of the present invention. With reference to FIGS. 2-5A, the steps of the method will now be explained. The method begins in step 30, where the total fan performance, or fan curves, over an operational range of air conditioning system 20 is determined by measurement. Next, in step 31, the fan curve data is collected and fit to a continuous mathematical function or relationship, mathematically described as: CFM=f(Torque, Speed). This function describes the entire continuum of blower curves for the specified configuration of the air conditioning system 20. Next, in step 32, a number of discrete, individual airflows are determined within the specified range as required by the application. In step 33, those discrete airflows are fit to a unique equation, with the coefficients of that equation describing an “airflow bin” that relates the speed and torque of the motor 24 over the narrow range of restrictions relevant to that discrete airflow. It should be notes that the equation only contains two variables—speed and torque. Airflow is intrinsically defined by this particular relationship of speed and torque. This equation does not describe a continuum of airflows, but only the relationship of speed and torque for one particular airflow. The one particular set of coefficients in this equation make the equation specific to one airflow only. It is emphasized that these steps are conducted prior to implementation of the control. By performing these pre-implementation steps described in FIG. 5a, the complexity of the fan curves are reduced to a simple set of coefficients that fit an equation describing discrete airflows defined by the fan curves. Step 34 (FIG. 5a) shows the table of coefficients selected by the process of FIG. 4 that are used in the controller 26 to fit the unique equation of the specified bin to control the RPM and torque of the motor to deliver the desired CFM according to the simpler speed-torque relationship thus developed.

In addition to the disadvantages discussed above for a general mathematical model that calculates CFM from the fan curves described in FIG. 1, another disadvantage of the generalized mathematical model of FIG. 1 is that consideration is not given to any speed and torque restrictions (except for a maximum torque that applies to any airflow in the range of permissible air flows). Because such a limit must be applicable to the highest airflow and would be constant so that it would apply to any airflow within the continuum, it would not be appropriate to most airflow values below the maximum. As a result, the blower might operate at inappropriately high or low RPM under high or low external restrictions.

For example, in an existing system utilizing a general mathematical model of FIG. 1, when a high airflow is commanded (e.g., 1200 cubic feet per minute), the total restriction at the inlet and outlet of the blower might cause the system and motor controller to compute and command a high torque, which may be near the maximum output of the motor. This high torque command results in the blower running at a very high RPM (e.g., greater than 1300 RPM). As a result, the blower would be noisy and have high power consumption because such RPM would be needed for the blower to deliver the commanded airflow into such a high restriction. Alternatively, at a much lower commanded airflow (e.g., 600 CFM), the same restriction on the blower does not require the blower to operate at 1300 RPM to deliver 600 CFM. Thus, there is no reason to permit such high speed operation of the motor at the lower commanded airflow. In addition, if the restriction on the system is increased so high as to force speeds approaching full blower speed at the lower commanded airflow, such operation would create unacceptably high blower noise and high power consumption.

In the preferred embodiment of the present invention, a variable limit across the full airflow range may be implemented to control and limit torque and speed within the air conditioning system 20. When the blower is requested to deliver less than the system's maximum airflow, the permissible torque limit may be reduced to a value appropriate to the blower's performance curves at lower airflow. With such limits in place, when the blower speed reaches the individual limit set for each particular selected airflow, the blower may automatically transition from an airflow control mode to a constant torque or constant speed mode in the presence of restrictions beyond what is reasonable for the airflow commanded. The effect of this transition would be that the blower stops accelerating to an excessive speed and permits the air volume to drop under the abnormally restricted condition.

FIG. 5b is a flow chart outlining the steps of implementing airflow control in the air conditioning system 20 utilizing a variable limit according to the teachings of the present invention. With reference to FIGS. 3-5b, the steps of the method will now be explained. The method is a continuation of FIG. 5a, steps 30 through 34, in which the total fan performance over an operational range of the air conditioning system 20 has been determined and the mathematical relationship of the airflow continuum, CFM=f(Torque, RPM), has been obtained. The number of discrete airflows has also been determined for the specified configuration of the air conditioning system 20 that will be implemented in the control to calculate a plurality of discrete airflows within the range. FIGS. 5a and 5b show that in addition to determining the discrete airflows within the specified range that are defined by a unique equation relating the speed and torque of the motor over the narrow range of restrictions relevant to that discrete airflow, minimum and maximum limits for both speed and torque are set for each discrete airflow selected for the application from the test data is shown in step 34. Next, in step 35, it is determined if a constant speed mode or constant torque mode is desired in the air conditioning system 20 when a limit is reached. Next, in step 36, the results of the pre-implementation process are programmed into the controller. As shown in step 36, the full control has been implemented and consists only of the table selector (FIG. 4), the coefficients table, the torque equation, the limits table, and the control process for applying control when in the limit conditions.

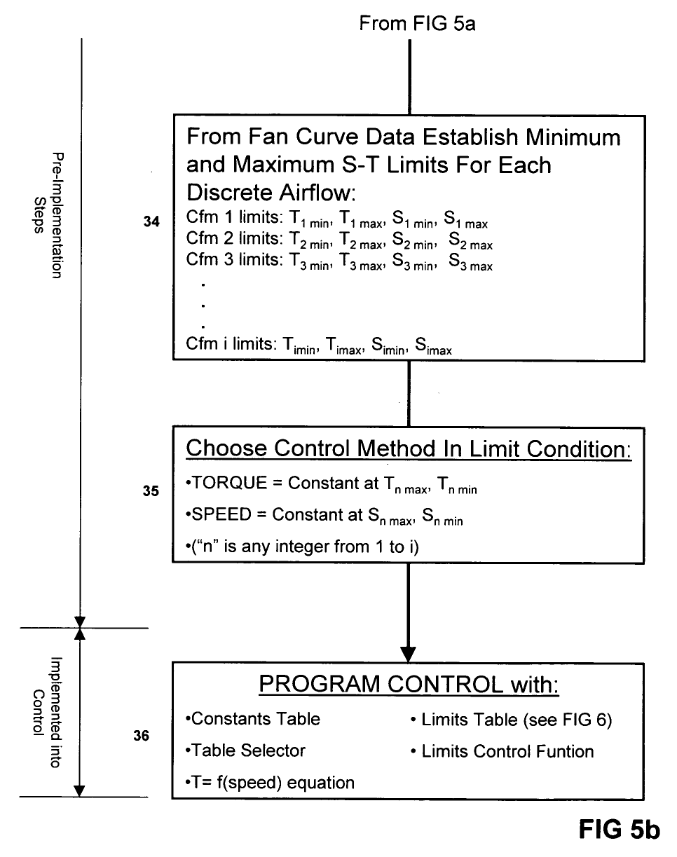

FIG. 6 is a flow chart expansion of step 36 in FIG. 5b. The flow chart outlines the steps of the full control process, including control in the limit conditions, according to the teachings of the present invention. Since speed is measured, a predetermined maximum speed may be established for each commanded airflow. At that maximum speed, the controller transitions the system from a constant airflow mode, in which the motor is commanded to a speed required to deliver the commanded airflow, to a mode in which the motor is no longer commanded to speed up in response to increased restriction in the airflow system. In this new mode, the controller can transition to a controlled-speed mode if speed is held constant at Sₙₘₐₓ by adjusting the command to the motor to hold the measured speed constant, or to a controlled-torque mode if the torque command is simply held at the maximum value, Tₙₘₐₓ, when at or above the maximum speed, Sₙₘₐₓ, for that airflow bin. An advantage of the present invention over prior art is that the maximum limit can be set at levels appropriate to each commanded airflow so that, for example, a high restriction at a low commanded airflow cannot cause the blower to speed up to excessive RPM. It should be understood to those skilled in the art that a motor's speed/torque can be controlled to a specified speed/torque. The controller determines the appropriate mode based on what is programmed within the controller as feasible for the airflow to prevent acceleration to an excessive speed and whereby air volume drop is appropriate. In step 133, the coefficients and limits from the selected discrete airflow are determined from the selection process illustrated in FIG. 4. Next, in step 134, it is determined if speed or torque is at a maximum or minimum limit for the selected airflow. If it is determined that the CFM control is appropriate and the limits for the selected airflow bin are not reached, the method moves from step 134 to step 136 where the controller 26 utilizes the unique equation of the specified bin to control the RPM and torque of the motor to deliver the desired CFM. However, in step 134, if the limits have been reached, the method then moves from step 134 to step 135 where it is determined if the controller is in a speed controlled or torque-controlled mode, depending on which technique was preferred for the application and has been pre-programmed.

In step 135, If it is determined that the constant torque mode is appropriate, the method moves from step 135 to step 137 where the controller commands constant torque. This mode stops the blower from accelerating to an excessive speed and permits the blower to respond to normal fan curve performance, allowing the air volume to drop under the abnormally restricted condition. So long as the blower speed stays at or above the speed limit for that bin, the method continues to take the path of steps 134, 135, and 138. When or if the speed of the motor returns within the limits for the selected airflow, the process reverts back to 134 where the controller continues to determine the appropriate mode of operation (constant CFM or constant torque).

An example where such a variable limit methodology is particularly advantageous can be seen in a non-ducted, free discharge blower whose discharge vents are accessible in the conditioned space. In such systems, restrictions can easily be inadvertently created on the air delivery system. For example, a small fan coil or air conditioning blower in a school classroom may have papers or books placed on its discharge registers. With a constant CFM-controlled blower, the blower changes speed dramatically to maintain the same airflow that was present before the addition of the outlet restrictions. In the situation where airflow was already at a high level of delivery, the blower may be operating at some maximum limit. Therefore, in such a situation, higher velocity would be acceptable. However, if the blower was operating at a low airflow, placing paper or books on the discharge registers might add enough restriction to the system to drive the blower to a very high RPM. By utilizing the variable limit methodology described in FIGS. 5a and 5b, the controller would only permit the torque or speed to be increased to take the RPM to a specific point, at which point the torque is commanded to a constant or lower level thereby preventing excessive speed and inordinately high power consumption of the air conditioning system.

Advantages may also be seen within ducted air conditioning systems at maximum airflow utilizing the methodology of FIG. 6. In a system employing a constant CFM model, the blower may accelerate to high speed, consume high power, or cause erratic blower operation at excessively high restrictions due to blower cavitation. With the bin discrete computational processes discussed in FIG. 4, the maximum airflow condition could be set to a different speed/torque performance equation than would apply at lower airflows. As a result, a self-limiting relationship may be implemented so that the blower motor does not speed up to the point of cavitation.

Referring back to FIG. 2, the curved line labeled “Max Limit” represents the maximum torque and speed allowed across the discrete CFM range. Correspondingly, the curve labeled “Min Limit” represents the minimum values of speed and torque allowed for any given discrete CFM. The curves labeled “lines of constant CFM” each represent a constant CFM up to a point intersecting the limit. With the improved algorithm, the speed/torque response of the motor is allowed to reach a torque or speed limit appropriate to each individual airflow within the range of airflows. A minimum torque limit would also be utilized to maintain motor operation and prevent stall under very low airflow.

By utilizing a controller based upon a mathematical model specific to a unique geometry of the blower permits development of algorithms that are suitable for forward curved or backward included blower wheels. Since performance characteristics of these two types of wheels are completely different due to their geometry, it is not practical for one mathematical model to adequately characterize both types of blower wheels. In the preferred embodiment of the present invention, a mathematical model is tailored to each type of blower system and employs the discrete bin equations to fit the performance over a small range of operation. Prior algorithms were not adequately capable of modeling backward-inclined blower wheels. In addition, these existing mathematical models cannot split the performance region into smaller, mathematically definable bins. The preferred embodiment of the present invention permits each bin to be constrained to speeds and torques appropriate to the defined region and permits each region to have unique and separate upper and lower limits on speed and torque. In backward-inclined blower wheels, it is particularly critical to determine these characteristics. Backward-inclined blower wheels exhibit a non-overloading characteristic that causes power to reduce as pressure reduces toward free delivery, especially at the lower external pressures at low RPM in a fixed restriction system.

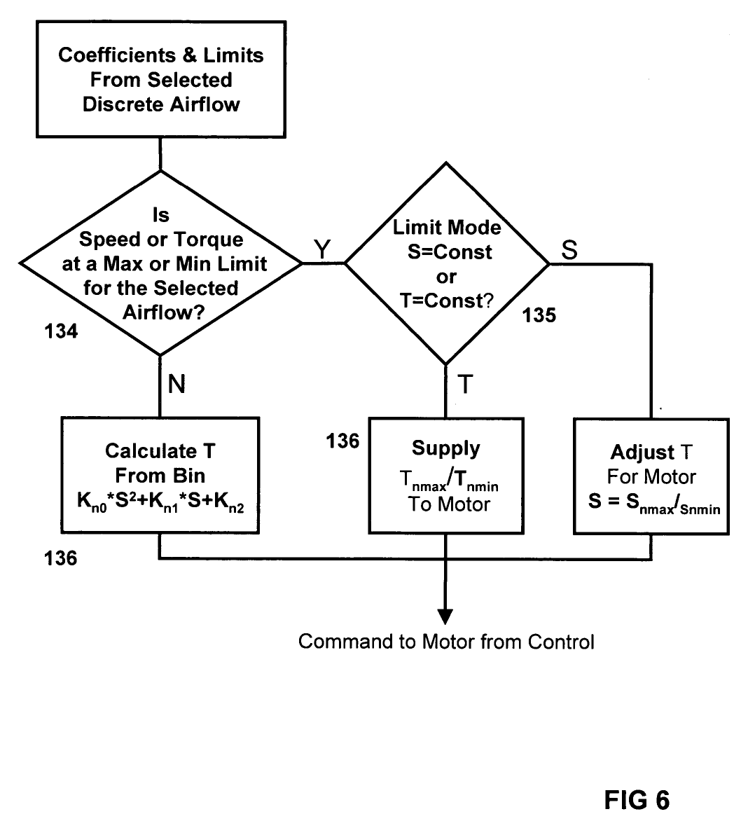

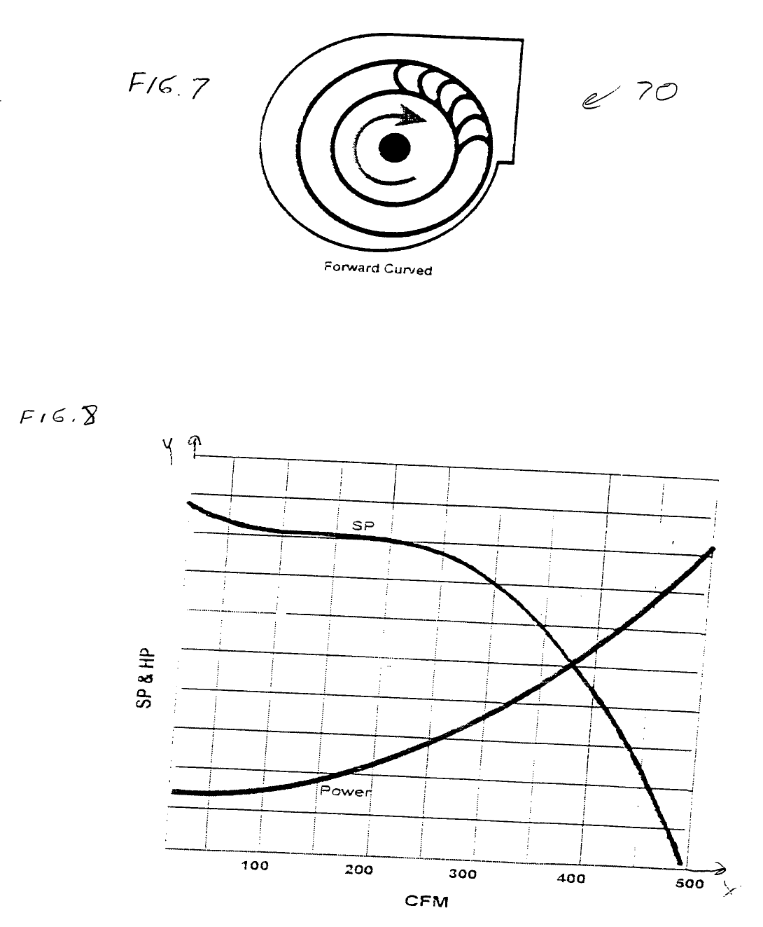

FIG. 7 illustrated a top view of an existing forward curved blower 70. FIG. 8 illustrates the blower characteristics of the exemplary forward curved blower 70 of FIG. 6. As illustrated, the power/torque loading constantly increases.

Due to the contrasting performance characteristics, it is evident that a discrete regional bin CFM approach is far more accurate and practical then any existing methodology.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

1. An air delivery system, the air delivery system comprising:
a blower for delivering an airflow to a specified area;
a motor for driving the blower; and
a controller for controlling air delivery to the specified area;
the controller controlling the air delivery by computing a torque command for the motor to produce a desired cubic feet per minute (CFM) airflow;
wherein the controller approximates a continuum of airflows over an operating range of the blower by dividing the continuum of airflows into a plurality of discrete airflow bins, each discrete airflow bin being a mathematical function relating a speed and torque of the motor with a specific discrete CFM airflow;
whereby the controller selects a specific mathematical function from a plurality of discrete mathematical functions to calculate the airflow bin for a desired CFM airflow, the controller selecting a motor speed within the airflow bin to compute the torque command necessary for the motor to drive the blower.

2. The air delivery system of claim 1 wherein the mathematical function relating torque and speed of the motor to define each discrete airflow has up to three coefficients and is defined as a quadratic equation.

3. The air delivery system of claim 2 wherein one of the three coefficients is zero, thereby defining a linear function.

4. The air delivery system of claim 1 wherein the controller commands the motor to drive the blower with the calculated torque command such that a blower speed is developed to produce a requested airflow when a specific range of pressure restriction is applied upon the blower.

5. The air delivery system of claim 1 wherein the controller does not require a current input from the motor for controlling air delivery.

6. A method of controlling an air delivery system, said method comprising the steps of:
determining a total fan performance of a blower driven by a blower motor over an operational range of the air delivery system;
approximating a continuum of airflows over an operating range of the blower by dividing the continuum of airflows into a plurality of discrete airflow bins, each airflow bin relating a speed and torque of the motor with a specific discrete cubic feet per minute (CFM) airflow; and
implementing the airflow bin to control the speed and torque of the motor to deliver a desired CFM airflow.

7. The method of controlling the air delivery system of claim 6 wherein each unique mathematical function includes relating the speed and torque of the blower motor to a singular discrete airflow within a narrow range of pressure restrictions relevant to that singular desired CFM airflow.

8. The method of controlling the air delivery system of claim 7 wherein each unique mathematical function is a quadratic equation.

9. The method of controlling the air delivery system of claim 7 wherein each unique mathematical function is a linear equation.

10. The method of controlling the air delivery system of claim 6 further comprising the steps of:
determining if a constant airflow mode or a constant torque mode is desired for the air delivery system;
if a constant airflow mode is determined, utilizing by a controller of the air delivery system the unique mathematical relationship for a specific discrete airflow to control the RPM and torque of the motor to deliver a desired CFM airflow.

11. The method of controlling an air delivery system utilizing a variable limit of claim 10, further comprising the step of if a constant torque mode is desired for the air delivery system, commanding by the controller a constant torque to the motor to allow the blower to follow a fan curve performance model.

12. The method of controlling an air delivery system utilizing a variable limit of claim 10 wherein each discrete air flow is defined by a unique equation relating speed and torque of the motor over a narrow range of restrictions relevant to that discrete airflow.

13. The method of controlling an air delivery system utilizing a variable limit of claim 8 wherein said step of determining if a constant airflow mode or a constant torque mode is desired for the air delivery system includes determining if the desired CFM airflow results in an excessive speed of the blower.

14. The method of controlling an air delivery system utilizing a variable limit of claim 9 wherein said step of determining if a constant airflow mode or a constant torque mode is desired for the air delivery system includes determining if the desired CFM airflow results in an excessive speed of the blower.

15. The method of controlling the air delivery system of claim 6 wherein the unique mathematical functions form an overall mathematical relationship providing a fan curve that relates the required speed and torque in the motor to the airflow delivered by the blower.
